(19) United States
(12) Patent Application Publication
(10) Pub. No.: US 2003/0002168 A1
(43) Pub. Date: Jan. 2, 2003

(54) 3-D display system

(76) Inventors: Steve Richfield, San Jose, CA (US); Steve Edward Richfield, San Jose, CA (US)

Correspondence Address: Steve Richfield, Suite 109-751, 2910 Stevens Creek Blvd., San Jose, CA, 95128, US

(21) Appl. No.: 09/895,616

(22) Filed: Jul. 2, 2001

(51) Int. Cl. G02B 27/14

(52) U.S. Cl. 359/634

(57) ABSTRACT

A 3-D display system utilizing a mirror as a “screen” that concentrates the light from each projector onto the appropriate eye of the user, in conjunction with a beam splitting mirror and various means of delivering a 3-D image without superimposed phantoms. Variations are capable of complete surrounding “Holodeck” style displays, and of moving-observer and multi-observer operation. A 3-D treadmill for “Holodeck” style displays is also presented.

I am placed into quite a dilemma here. I am required to place my invention within the existing patents, but these are rife with defective and duplicative disclosures and WAY too over-broad claims. Unfortunately, I can see no way for me to do my job in a way that fails to challenge clearly defective claims on recently granted patents that claim just about everything that has ever existed in this field clear back to 1936. Hence, I have elected to simply “calls em as I sees em” and let the chips fall where they may. I hope and expect that the Patent Office will seek to cure at least some of these very serious problems that I point out here, and then edit or delete my references to those problems in this patent application prior to publication. I also stand ready to withdraw any inappropriate challenges to existing patents. Hence, I hereby authorize the Patent Office to perform such edits and deletions for problems that are repaired or prove unreal, but NOT to edit or delete references to continuing problems that are not cured by the time that this patent is issued.

Sorry about that, but if I am to successfully receive any licensing revenues from this patent from prospective licensees who do their own patent searches, then this patent MUST visibly disclaim the erroneous claims of other patents that on the surface seem to claim the present invention. This way, prospective licensees know that the Patent Office has seen and approved these statements regarding patents that have not been corrected.

If the Pentagon is to achieve its goal to promote new 3-D display development for military training applications, then it must be possible to effectively patent new developments in this area. To this end, the US patent office should review this entire area and annotate or flush out those patents with unworkable and/or repetitious disclosures and over-broad claims, especially where they erroneously read into this domain.

CLAIM #1 IN U.S. Pat. No. 6,078,423 CONSTITUTES A NATIONAL HAZARD, as it depreciates the value of other good patents in this area and impedes new 3-D display development, which has been identified as a national priority by the Pentagon. It appears to be in the national interest that this particular claim be conspicuously invalidated ASAP, though this will probably be complicated by the fact that this is a PCT application from the UK, and so doubtless already has force in other countries, who should also invalidate it.

It appears that some reorganization of 3-D display technology is in order to avoid the future repetition of situations as described above. Many recent 3-D patents involve methods that require the eyes to focus on some part of the device, a really major limitation that SEVERLY limits depth perception and that demands other offsetting advantages, such as ruggedness. This would seem to be a good basis on which to split future 3-D display subclasses.

Making sense of existing and future 3-D patents may require skills and experience that are not presently available at the US Patent Office, as this field if often governed more by the subtle effects of what is missing rather than the intended effects of what is there. While most fields develop through adding new components to achieve new functionality, it appears that for the time being that 3-D is to develop through getting the basics right. This includes being able to produce a clean image under normal lighting conditions with a reasonably priced apparatus, as has yet to be done prior to the present invention. The present inventors hereby offer their services—some for free and more under contract, to assist the US Patent Office in straightening this entire field out.

### BACKGROUND OF THE INVENTION AND ANALYSIS OF PRIOR ART

Despite an apparently ample patented base of technology that predates both television and electronic computers, high quality 3-D displays that don't require special glasses are still unknown in the present-day marketplace. It seems important to understand just why this has happened, not just for historians, but to understand the place of the present invention in this puzzle

This technology apparently requires the use of one of the following:

A large off-axis, high numeric aperture, precision aspheric concave mirror. Presently these are prohibitively expensive to manufacture in small quantities, e.g. for prototyping. These would have been required for some of the early patents when there was no known method of manufacturing these, so presumably no functioning unit has ever actually been constructed using one of these. Two embodiments of the present invention utilize these.

A large positive lens. These produce simple and robust designs, but limit screen size to a few inches.

An inexpensive large spherical mirror in conjunction with a beam splitting mirror. This requires the optical eye-to-mirror distance to equal the optical mirror-to-projector distance, and requires perpendicular viewing of the image. This situation could not exist without the users head and the projector either occupying the same point in space, or at least being in each other's way, were it not for the use of a beam splitting mirror. These systems are simple to envision but difficult to make to work adequately, as there are more extraneous light paths than there are productive light paths. Hence, the real challenge in these designs lies not in the formation of a 3-D image, but in the effective control of extraneous light to avoid phantoms being superimposed onto the image, a complex problem about which there is no clue in any existing patent. Note the lack of recognition or indication of the extraneous light paths in the drawings of any prior patent application, which often do include the utilitarian light paths. Light is typically shown just reflecting from or passing through a beam splitting mirror, whereas in real life it will always do both.

A concave mirror with a small numeric aperture and consequent narrow viewing-angle. These are good for demonstrations and even a common shaving mirror is serviceable for simple demonstrations. However, this approach does not lead to acceptable viewing angles for commercial or military applications.

U.S. Pat. No. 2,045,120 (1936): The basic principle utilized by the present invention was patented. Looking at the drawings, the inventors were envisioning a movie-theater sized off-axis precision aspheric concave mirror, yet the image could be viewed by only a handful of viewers. Having never seen a television, apparently the inventor never considered a small screen, which works just as well as a large screen since the viewing angle is the important parameter. There was no known way to construct a movie theater sized off-axis precision aspheric mirror for any amount of money utilizing the technology of the 1930s, and this would still be quite a challenge even today.

U.S. Pat. No. 2,391,675 (1945): The first practical device utilizing a large lens as a small display is patented. This is a special-purpose device, apparently for the purpose of viewing sequential aerial photographs.

U.S. Pat. No. 2,570,654 (1951): This improves U.S. Pat. No. 2,045,120 without referencing U.S. Pat. No. 2,045,120, adding a collaborator which provides means to construct a complete 3-D movie theater for many users where the users need no special glasses. This method presumes large projectors and widely separated viewers, and is considerably more complex and expensive than the collaborator in the present invention. This inventor also failed to realize that small screens work as well as large screens, so this device was doubtless never constructed.

Now the basic principles had been patented. For the next 50 years, most future inventors will stumble into existing patents and give up, will patent other less effective methods, or will fail to discover these patents and reinvent existing technology unless discovered by US Patent Office personnel, a process repeated several times. Not readily apparent are a variety of fatal flaws plaguing these and future patents, leaving lots of room for further development.

1958: Steve Richfield, the first named inventor of the present invention, constructed a functioning 3-D display at the age of 13. Steve reinvented and constructed this as a working proof-of-principle device that was very similar to U.S. Pat. No. 2,045,120. The projectors were constructed inside of a cigar box, using a stereoscope slide as an image source, binocular objective lenses projected the image, and a shaving mirror was used as the screen. Id worked spectacularly well, being able to present crystal-clear lifelike objects from in front of the screen all the way out to infinity. Indeed projector alignment was adjusted with the use of a pair to binoculars to examine objects at infinity, which looked surprisingly good even with 7× magnification.

U.S. Pat. No. 3,447,854 (1969): The first 3-D display device utilizing a beam splitting mirror is patented, which is similar to one of the present embodiments. However, it contains a variety of really serious design flaws and could not have worked adequately as disclosed. No subsequent devices with any of the flaws addressed were patented, so this idea probably died without ever becoming a viable product.

The problems with U.S. Pat. No. 3,447,854 are as follows. Much of the light from the projector will go through the front screen and illuminate the keyboard area, reflect back, and then reflect off of the front screen and be superimposed onto the image. There is no simple fix for this problem, as it arises from the geometry of this system. Also, some of the light that falls around the user's eyes will reflect back through the screen, reflect off of the concave mirror, pass back through the screen, and re-emerge onto the user's eyes to be also superimposed on the image.

This failure to control extraneous light also plagues future patents regarding stereoscopic methods that utilize beam-splitting mirrors.

U.S. Pat. No. 4,232,968 (1980): Another patent with some features of the present invention is granted. However, it too suffers from technical problems in its disclosure. The optical path from the mirror to the user is considerably shorter than the path from the mirror to the image source. This means that the mirror would have to be ellipsoidal shaped (akin to the small end of an egg) and hence lose the cost-saving benefits to be derived from the use of a beam splitting mirror. It is unclear which type of error this is, i.e.:

Is FIG. 1 simply very much not to scale?

Does this contain a serious design error, e.g. due to the introduction of spherical aberration due to the different optical distances from the mirror to the user and from the mirror to the projectors?

A Was the inventor envisioning the use of an expensive aspheric mirror, in which case why didn't the eliminate the problematical beam splitting mirror in favor of an off-axis mirror?

Further, this invention also lacks stray light control, so that projected light reflecting off of the beam-splitting mirror will illuminate the edges of some of the internal mirrors, which will then be superimposed on the image. Further, light reflecting off of the user's face will then reflect off of the beam splitting mirror, reflect off of the concave mirror, reflect again off of the beam splitting mirror, and be superimposed on the image. Hence, this device also has serious designed-in problems.

U.S. Pat. No. 4,322,743 (1982): The first patent that addresses the multiple user viewing of electronically generated images is granted. Unfortunately, this involves separate projection means for each eye of each observer, and fails to consider astigmatism in the main viewing mirror, which will limit the usable viewing angles to less than that shown. Also, the distribution of the projection means (1-8 on FIG. 1) around the image source will cause serious focusing and keystone distortions of the image for off-axis users, and serious differences in focusing and keystone distortion for the separate eyes of all users. Hence, no practical multi-viewer design was disclosed. The independent claims are WAY too over-broad, covering nearly all of past 3-D technology.

U.S. Pat. No. 4,840,455 (1989): Minor improvements to U.S. Pat. No. 4,232,968 are patented. However, this device still appears to suffer from the same designed-in problems as U.S. Pat. No. 4,232,968.

U.S. Pat. No. 6,078,423 (2000): A 3-D display device, whose only independent claim covers nearly everything involving multi-user 3-D, going all the way back to U.S. Pat. No. 2,570,654 and including U.S. Pat. No. 4,322,743, is granted. Note that U.S. Pat. No. 6,078,423 refers to neither of these patents.

Apr. 9-11, 2001: The following organizations joined together:

The US Army's Simulation, Training and Instrumentation Command (STRICOM)

The US Navy's Naval Air Warfare Center Training Systems Division (NAWCTSD)

The US Air Force's Training Systems Product Group (TSPG)

The US Marine Corp's Program Manager Training Systems (PMTRASYS) and presented their needs for 3-D simulation systems at the Joint Department of Defense Advanced Planning Briefing to Industry (APBI) for industry leaders, including John Garman with Precision Imaging Corporation (PIC) of San Jose, Calif., a leading manufacturer of aircraft simulator displays.

Steve and Eddie Richfield subsequently met with John Garman to consider this long-dormant 3-D technology for military training applications, which eventually resulted in the present invention.

The essence of the present invention concerns the construction of displays utilizing beam splitting mirrors while effectively controlling the effects of stray light on the image, constructing low-cost image collaborators suitable for small displays and closely spaced users, and critical details of constructing fully surrounding “Holodeck” style displays.

### BRIEF SUMMARY OF THE INVENTION

A display system that provides for the display of large high-quality electronically generated 3-D images that can be viewed without special glasses, and presented with a focal distance appropriate to the material being presented. Variations are capable of complete surrounding “Holodeck” style displays, and of moving-observer and multiob-server operation A 3-D treadmill for “Holodeck” style displays is also presented.

The present approach provides for appropriate focal distance while providing a very high quality image, and is adaptable to a variety of embodiments to fit various needs.

The present invention focuses the light from the viewing mirrors onto the user's eyes, so that most or all of the light from each projector reaches one side of the user's face. Seen in a dark room, the user's face typically has two lit areas, each generally around an eye.

The common features shared by these embodiments include:

1. A pair of projectors, one for each of the two stereo views.

2. An optional image collaborator described herein, to make the two projection lenses appear to be several pairs of projection lenses.

3. An optional electronic means to move the projectors or mirrors to track a moving user.

4. Mirrors to direct the light from the projection lenses to the screen. These may be flat, or curved as in a Cassegrain-like system.

5. A mirror acting as the screen. This either an ellipsoidal mirror, with the user's eyes at one of the foci, and the projectors at the other foci, or a spherical mirror in conjunction with a beam splitting mirror and means to control stray light.

Image Collaborator

Many 3-D display applications require that more than one person be able to simultaneously view the 3-D image. Training applications often require a teacher's intervention, and games are even better with spectators.

However, the requirements of collaborative viewing differ from one application to the next. A medical simulation system must show things in the foreground at the same points in space in front of the display for all users, without significant parallax error. A video game need only present the same scene to all users, without attention to presenting things at the same points in space for each user.

The present image collaborator not only allows viewing my several people, but it can be set, adjusted, or electronically controlled to make the images coincident at a selected distance in simulated space, enabling those applications that would otherwise require projector pairs with associated computer support for each user.

The ubiquitous automotive tilting rear view mirrors provide a means to dim the image utilize the same principle, in that they divert the same image into two different directions. The image collaborator consists of a plurality of semi-reflecting mirrors, typically glass that has been low-reflection coated on one side, spread out into a fan-like arrangement to direct the light from each projector into the plurality of different directions needed to reach a plurality of different users. In effect, these make spatially separate phantom projectors by optical means A narrow-angle prism, akin to the glass in an automotive rear view mirror, provides two semi-reflecting surfaces. Several prisms provide more surfaces to serve more users. Even plain uncoated flat glass sheets provide serviceable results, though the double reflection from the parallel surfaces degrades the images.

3-D Treadmill

The 3-D treadmill consists of a plurality of small lateral treads with guides attached together to form a complete tread. As the tread is moved as with a conventional treadmill, new lateral treads will be moved into place as others move out of place. A second drive mechanism drives the lateral treads that are in place for the user to stand on. By operating the lateral and/or main tread drives, it is possible to move the surface in any direction, so that a user can walk in any arbitrary direction. By using translucent plastic lateral treads and guides, and either an image source or colored lights beneath the surface can simulate grass, dirt, or other surface appearances for a complete “Holodeck” simulated experience.

By putting the treadmill onto hydraulic rams or other means to adjust height and tilt, it is possible to simulate a wide variety of hills and unsteady surfaces.

Note that the control system for the treadmill must generally keep the user at the center of the mechanism. The real-life equivalent would be slippery ice, where people would remain where they are despite attempts to move. Obviously, simulating ice isn't desirable unless that is what is wanted, as this would make the user's footing unstable. To correct this, it is necessary to allow a user to move when they decide, then gradually return them to the center. However, allowing such movement would disturb the optical arrangement so that the image would break up. To correct this problem, the main ellipsoidal optical element must have enough movement to allow the user to move about the surface of the treadmill. The treadmill control system must control the position of the main ellipsoidal optical element in coordination with the treadmill, so that the user can keep their balance as they start and stop walking in any direction, and also maintain the image.

Note that this treadmill may have application aside from use as part of a 3-D display system; e.g. exercise applications where the user can walk in any direction.

### BRIEF DESCRIPTION OF THE DRAWINGS

FIG. 1: Cross sectional side view of single stationary-user laptop 3-D computer system. This is the simplest embodiment of the present invention. Two projectors project phantom images, whose light is then gathered and separated by (2) and directed to the appropriate eyes (1).

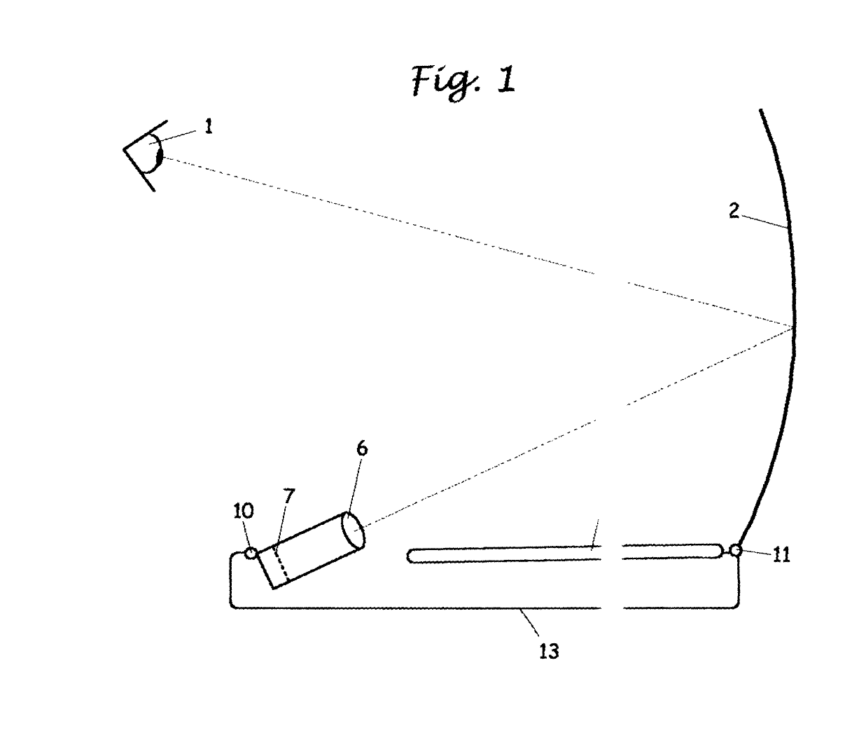

FIG. 2: Cross sectional side view of single moving-user 3-D Holodeck. This provides a completely surrounding simulated environment. A 360° extension of FIG. 1 with a 3-D treadmill and true separately delivered stereo sound.

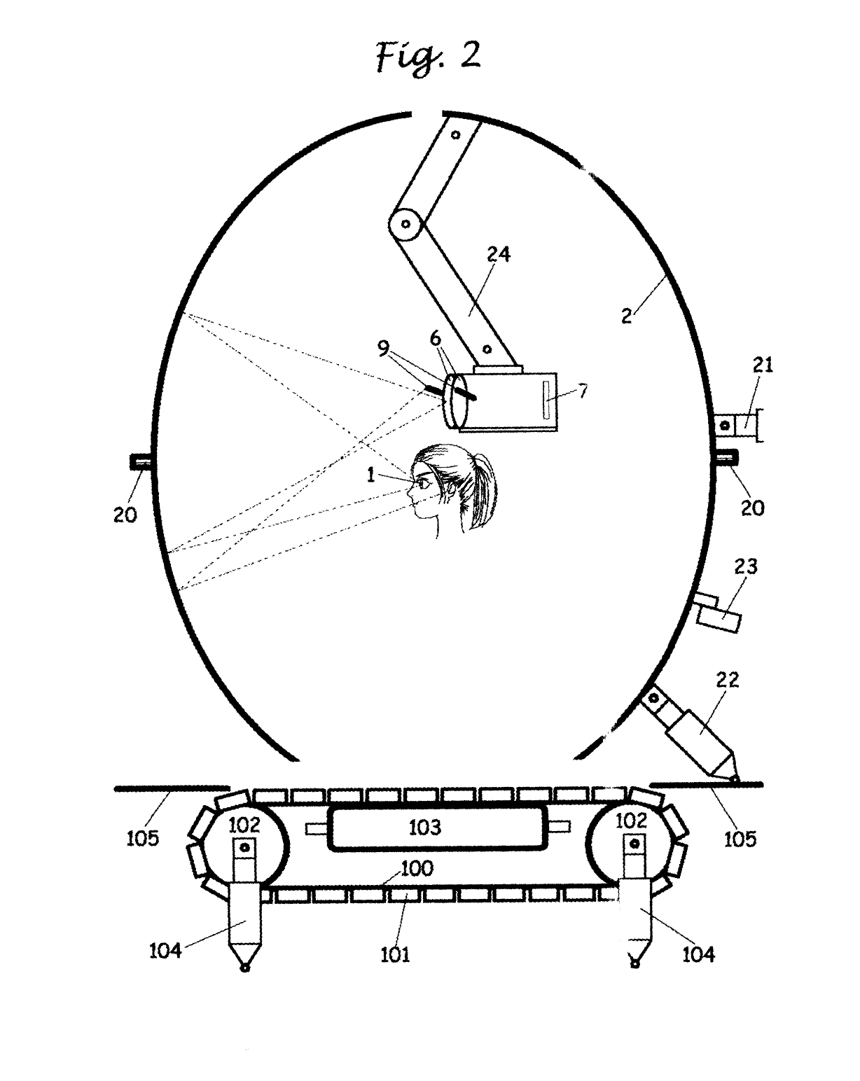

FIG. 3: Cross sectional side view of single stationary-user 3-D TV/Computer Monitor. This allows the use of inexpensive spherical mirrors as view screens. Two projectors project phantom images, whose light is reflected off of a mirror (4), to a semi-reflecting mirror (3), and then gathered and separated by (2), and sent through the semi-reflecting mirror to the appropriate eyes (1). Extraneous light falls on light traps (8).

FIG. 4: Cross sectional top view of Image Collaborator detail, used to enhance other embodiments for use by a plurality of simultaneous users. The detail shown is above or below the mirror and user, and either utilizes an aspheric concave mirror or a spherical concave mirror in conjunction with a beam splitting mirror. Light bounces off of semi-reflecting mirrors (5) to be sent in various directions to be gathered and separated by (2) and directed to the appropriate eyes (1).

### DETAILED DESCRIPTION OF THE INVENTION

The following is a detailed discussion of the components. Common component numbering is used across all drawings to avoid confusion.

1 is the user's eye or eyes. 2 is the main viewing optical element, which is a concave spherical or ellipsoidal mirror in the embodiments shown The main viewing element focuses the light from each projector onto the particular eye that the image from that projector was intended for. This may be a concave transparent component with the backside painted black to reduce the brightness of the reflection from the user's own face. 3 is a semi-reflecting mirror, which may be a piece common glass pane, which is either darkened or has one side low-reflection coated to avoid double images from reflections from both sides Darkening also reduces the effects of stray light. This allows the use of inexpensive spherical mirrors as the main viewing element. 4 is an intermediate mirror to fold the optical path to make the unit more compact.

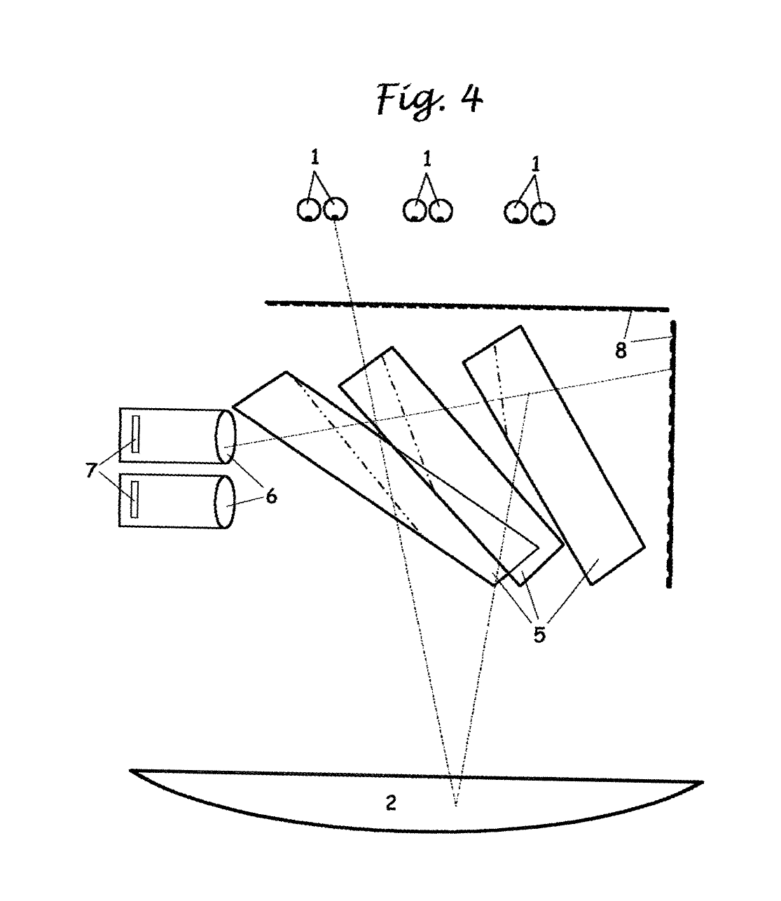

5 are semi-reflecting mirrors that pass most of the light, which may be pieces of common glass pane that is low-reflection coated on one side. These are carefully spaced and angled so that the light from each projector bounces off of them and after reflecting off of the main viewing element, proceeds to the same sided eye on a different user than the other semi-reflecting mirrors direct their light to. These may be used in conjunction with other components not shown on FIG. 4, such as 3, or 24, or used in substitution for 4 to implement a multiple-user monitor utilizing a spherical mirror for the main viewing element, Note that the spacing between these elements determines the point of apparent coincidence between the images seen by the various users. This is particularly important when the images appear between the users and viewing element, as in surgical simulations, so that all users see the same simulated point being cut by a scalpel.

6 is a lens and 7 is an image source that comprise one of the two projectors needed to produce the different images for the right and left eyes. 8 are light traps, which are needed to keep extraneous unwanted residual light from the semi-reflecting mirror systems from detracting from the image quality. 9 are sound output means, which are focused onto the individual ears by the same main viewing element as focuses the light from the projectors onto the individual eyes. They must extend from the projector as shown, so that the sound reaches the desired ear. 10 is a means of deploying the projectors or other optical means, so that the unit can be folded up for carrying. 11 is a means of deploying and adjusting the main viewing element. 12 is the keyboard. 13 is the enclosure.

20 is the seam where the two separately manufactured halves of the main viewing element are attached to each other. 21 and 22 are means of moving the main viewing element, which is necessary so that the user can start and stop walking without loosing his balance.

23 is one tactile effector, of which there may be a plurality. These simulate touching and bumping simulated objects. These may be mechanical devices similar to motorized automobile antennas, pneumatic devices that bump the user with puffs of air, or other suitable means to simulate touch. A paintball gun might be used to simulate gunshot wounds, e.g. at the conclusion of an unsuccessful simulated encounter

24 a means of moving the projector or intermediate mirror to keep the projector lenses located so that the light reaches the desired eyes. While 21 and 22 absorb larger starting and stopping movements and the treadmill keeps the user generally within the effective optical area, 24 must track rotational changes in the user's attitude and movements that are too quick to track by moving the entire optical element.

100 is the main treadmill surface. 101 is one of a plurality of semi-transparent lateral mini-treadmills. 102 are the wheels that move the main treadmill surface. 103 is the means to move the lateral mini-treadmills that comprise the portion of the surface that the user stands on. 104 is means to tilting, raising, or lowering the treadmill to keep the users eyes at the proper altitude and to simulate sloping or heaving ground surfaces that can also give way. 105 is the floor surface not otherwise taken up by the main treadmill surface.

Aberration Analysis

The key to the inexpensive construction of any optical device lies in careful design that is insensitive to the minor aberrations in its components. The present invention capitalizes on this.

Only a portion of the projection lens or mirror that is approximately the size of the pupil of the user's eye is actually used at any one time. Hence, variations in performance across the projector's lens or mirror do not significantly degrade the quality of image as seen by the user, so inexpensive components can be used.

Errors in the shape of the main screen's mirror or lens have little effect on the image quality, provided that they are not so excessive so as to completely miss the user's eyes with the projected light. The only problem that lesser aberrations cause is in slightly distorting the appearance of images whose apparent distance is substantially different than the distance to the main screen's optical element. Indeed, a conventional movie theater, complete with its light-scattering screen, constitutes the ultimate maximally distorted mirror, and most users don't complain about the error in focal distance while viewing a television or a movie in a theater. Hence, residual aberrations that still deliver the light to the user's eyes are of little consequence to the operation of the present invention.

Lighting Analysis

Depending upon the particular design, as much as 1% of the light from the projector can end up in the user's eyes, which is many orders of magnitude more than other projection systems. Hence, only tiny amounts of light are needed for this system, so Christmas tree lights are more appropriate than high-power projection bulbs. Hence, while some embodiments may bounce images off of uncoated glass elements, loosing around 94% of the light in the process, this is really no practical problem or limitation. Further, the use of darkened glass reflecting elements eliminates the potential need for low-reflection coating, and often eliminates the potential for the user seeing his own reflection in the system, without increasing the losses beyond acceptable limits.

Acoustical Analysis

The egg-shaped ellipsoidal mirror provides such a high numerical aperture that sound can also be focused onto individual ears. Hence, separated stereo sound can be delivered to the user without the use of headphones, by emitting sound at points where the sound will be focused onto the desired ears. This also has the advantage of containing the sound within the apparatus, thereby avoiding external noise. Diffraction will distribute the sound over a half wavelength area, more than the viewing area, so aberrations are not an issue. Unfortunately, smaller screens have more acoustic diffraction, so this works best in the “Holodeck” configuration.

Echo Cancellation

In the surrounding “Holodeck” embodiment, sound from the user, whether made by the user or reflected off of the user, will be refocused onto the projector, then refocused back onto the user, causing an echo chamber effect that should be corrected to avoid annoyance. Soft padding the projector or a “chimney” to the outside helps a lot, but some form of active electronic echo cancellation may be necessary in some applications to provide desired ambiance, especially for open-air simulated environments.

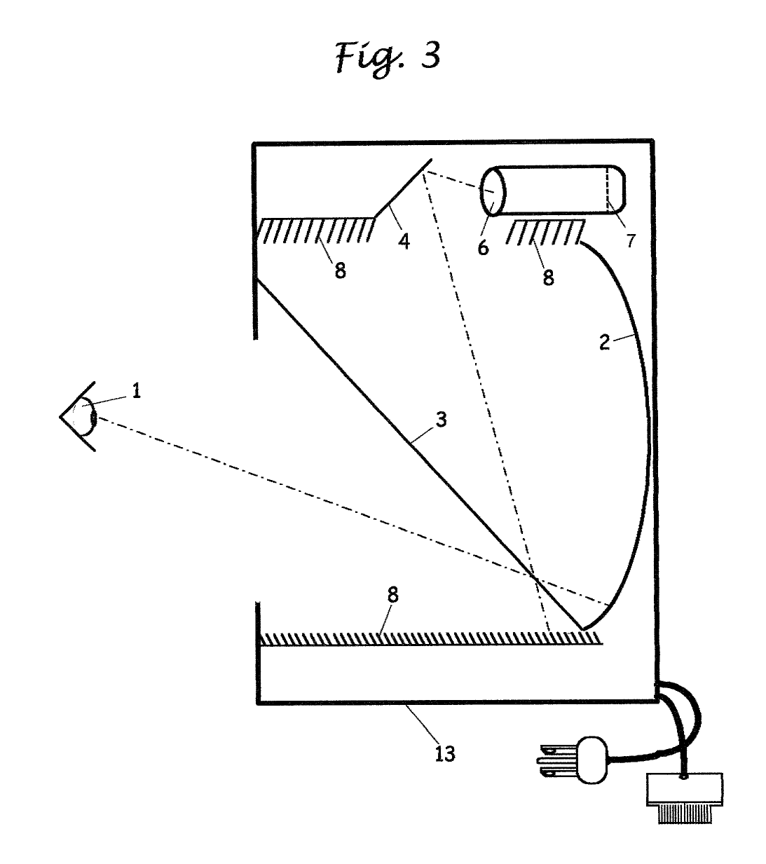

Only a few different embodiments have been presented herein, each intended for a different common product application However, once the novel operating principles described herein are fully understood, any competent optical and mechanical engineers can doubtless adapt them to other product requirements through conventional engineering practice. For example, in FIG. 3, the concave mirror (2) and the lower light trap (8) could be interchanged to accommodate various product needs and characteristics of the available optical components.

What we claim as our invention is:

1. A 3-D display consisting of:
A spherical concave viewing mirror.
A diagonal beam splitting mirror to direct light from the two projectors perpendicularly into a spherical mirror, while simultaneously allowing the user to perpendicularly view the mirror.
Means of absorbing extraneous light from the projector and/or the user's face that passes through or reflects off of the beam splitting mirror, depending upon the optical arrangement.

2. A 3-D display as in claim 1, utilizing a low-reflection concave spherical mirror to reduce the amount of light from the user's face that reflected back to become superimposed onto the image.

3. A 3-D display as in claim 1, utilizing an absorbing beam splitting mirror, to reduce the amount of light from the user's face and the light absorbing means that is returned to be superimposed onto the image.

4. A 3-D display as in claim 1, utilizing both a low-reflection mirror and an absorbing beam splitting mirror to reduce the amount of light from the user's face that is superimposed onto the image.

5. A 3-D display that uses an egg-shaped ellipsoidal mirror that a user can stand within to provide a complete 360-degree field of view.

6. A 3-D display, as in claim 5, whose optical surface is also used to focus stereo sound onto the individual ears of the user.

7. A 3-D display with optoelectric means to observe and track the user's eye location through the transmission of the image of the user's eyes backward through the display system. This coupled with means to adjust the physical position of optical components so as to deliver the images from the projectors to their respective intended eyes. This may include moving the projector, the screen, and/or any intermediate optical components.

8. A 3-D display with electromechanical means of controlling the focusing of the projector so that the focus can be dynamically adjusted for changing apparent object distances.

9. A 3-D image collaborator, consisting of a plurality of low-reflectance beam splitting mirrors in a fan-shaped configuration to spatially replicate projectors as needed for multiple users, and means to absorb light not otherwise directed to a user.

10. A 3-D treadmill, providing means so that users can walk around in any direction.

11. A 3-D treadmill as described in claim 10, with an electronic control system to keep user in the flat central area.

12. A walking surface display system, providing means for projecting colored lights or an image onto a translucent imaging walking surface, so that green grass, brown dirt, and other surfaces can be visually simulated.

13. A 3-D display with means to fold the projectors and viewing mirror into a compact portable unit.
